(19) United States
(12) Patent Application Publication
(10) Pub. No.: US 2012/0044680 A1
(43) Pub. Date: Feb. 23, 2012

(54) ILLUMINATING DEVICE WITH LIGHT EMITTING DIODES

(75) Inventors: Pao-Ting LIN, Hsinchu County (TW); Yu-Chu TSENG, Taipei City (TW)

(73) Assignee: LM OPTO CO., LTD., Hsinchu County (TW)

(21) Appl. No.: 13/084,580

(22) Filed: Apr. 12, 2011

(30) Foreign Application Priority Data
Aug. 19, 2010 (TW) 099127765

(51) Int. Cl. F21V 7/00; F21S 4/00

(52) U.S. Cl. 362/235; 362/249.02

(57) ABSTRACT

An illustrator with light emitting diodes provided in the invention includes a rear housing having a cavity. A front housing is disposed in the cavity, wherein the front housing includes through holes. An illuminating module is sandwiched between the rear housing and the front housing, wherein the illuminating module includes a substrate and light emitting diodes. Two opposite surfaces of the substrate are in contact with the rear housing and the front housing respectively and directly. The light emitting diodes are arranged on a surface of the substrate in an array arrangement and extending outward the through holes in a one-to-one relationship.

### RELATED APPLICATIONS

This application claims priority to Taiwan Application Serial Number 099127765, filed Aug. 19, 2010, which is herein incorporated by reference.

### BACKGROUND

1. Technical Field

The present disclosure relates to an illuminating device, more particularly to an illuminating device with light emitting diodes.

2. Description of Related Art

In daily life, illuminating apparatuses are necessarily important tools for people. Light bulbs or lamps of illuminating apparatuses are used as main light sources nowadays. Because these Light bulbs or lamps would consume more electric power when working, such as fluorescent lamps, incandescent bulbs, halogen lamps, or halogen bulbs, light sources mentioned above are replaced with modules made of light emitting diodes gradually in the present day for energy saving and carbon reduction.

However, light emitting diode modules would also generate thermal energy when lightening, so that generated thermal energy would be constantly accumulated for a long illuminating time. Finally, light emitting diode modules would have some problems about deterioration and illumination decay due to the accumulated thermal energy.

Generally speaking, a light emitting diode module is disposed in a light emitting diode housing (so-called MR16) so as to be protected by the light emitting diode housing. However, the light emitting diode housing cannot dissipate the thermal energy generated from the light emitting diode module efficiently. Therefore, the heat dissipation efficiency of the light emitting diode housing is insufficient. As such, the thermal energy would be constantly accumulated on the light emitting diode module to cause some chip deterioration problems. In addition, when the heat dissipation efficiency of the light emitting diode housing is insufficient, circuits formed on a substrate may be affected, such as short circuits or burned circuits because of the inadequate heat dissipation rate.

For these reasons, how to develop an illuminating device capable of solving the mentioned problems and disadvantages becomes a goal for the related industries to achieve.

### SUMMARY

One object of the present invention is to provide an illuminating device with light emitting diodes capable of enhancing heat dissipation efficiency by increasing a heat dissipation area of the light emitting diodes.

Another object of the present invention is to provide an illuminating device with light emitting diodes capable of enhancing heat exchange rate rapidly by increasing air convection passages.

An illuminating device of the present invention includes a rear housing, a front housing, and an illuminating module. The rear housing includes a first cavity therein. The front housing is disposed in the first cavity and includes a second cavity and a plurality of through holes therein, wherein the through holes communicate with the second cavity. The illuminating module is sandwiched between the rear housing and the front housing. The illuminating module includes a substrate and light emitting diodes. The substrate includes a first surface and a second surface opposite to the first surface, wherein the first surface is in contact with the rear housing directly, and the second surface is in contact with the front housing directly. The light emitting diodes are arranged on the second surface of the substrate in an array arrangement and extending toward the second cavity via the through holes one-to-one.

In an embodiment of the present invention, the substrate is a printed circuit board or a metal board.

In another embodiment of the present invention, the illuminating device further includes a power-connecting portion, wherein the power-connecting portion is disposed, on a surface of the rear housing opposite to the front housing.

In an embodiment of the present invention, the rear housing includes first air holes, and the first air holes communicate with the first cavity of the rear housing and outside air.

In an embodiment of the present invention, the front housing further includes second air holes, and the second air holes communicate with the second cavity of the front housing and the first cavity of the rear housing.

In a variation of the embodiment of the present invention, the second air holes are disposed on a sidewall of the front housing. In another variation of the embodiment of the present invention, the front housing includes an opening, wherein an edge of the opening includes a ring-shaped flange extending outward, and the second air holes are disposed on the ring-shaped flange.

In an embodiment of the present invention, an interior wall of a sidewall of the front housing surrounding the second cavity includes a reflecting layer.

In another embodiment of the present invention, a surface of the rear housing in contact with the first surface of the substrate includes a first insulating layer, and a surface of the front housing in contact with the second surface of the substrate includes a second insulating layer.

In another embodiment of the present invention, a surface of the rear housing or the front housing includes a heat dissipation layer.

The illuminating device with light emitting diodes of the present invention increases an area in contact with the light emitting diodes to highly reduce working temperature of the light emitting diodes, thereby decreasing the failure probability of the light emitting diodes. Furthermore, the illuminating device with the light emitting diodes of the present invention improves the condition of air convection so as to enhance the heat exchange rate.

### BRIEF DESCRIPTION OF THE DRAWINGS

FIG. 1A is a perspective exploded view in a direction of an illuminating device with light emitting diodes of an embodiment of the present invention.

FIG. 1B is a perspective exploded view in another direction of the illuminating device with light emitting diodes of the embodiment of the present invention.

FIG. 2 is a perspective view of a combination of the illuminating device with light emitting diodes of the embodiment of the present invention.

FIG. 3 is a front schematic view of the illuminating device with light emitting diodes of the embodiment of the present invention.

FIG. 4 is a cross-sectional view taken along line 4-4 of FIG. 3.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

An illuminating device with light emitting diodes is provided in the present disclosure. The illuminating device includes a rear housing, a front housing, and an illuminating module. The front housing includes through holes. The illuminating module is sandwiched between the rear housing and the front housing. The illuminating device includes light emitting diodes extending through the through holes in a one-to-one relationship.

As such, due to the illuminating module sandwiched between the front housing and the rear housing, the thermal energy generated from the working illuminating module can be transmitted away from the illuminating module by the front housing and the rear housing. Thus, the present disclosure increases the heat dissipation area Of the illuminating module to highly reduce the working temperature of the light emitting diodes, thereby decreasing the failure probability of the light emitting diodes caused by high temperature.

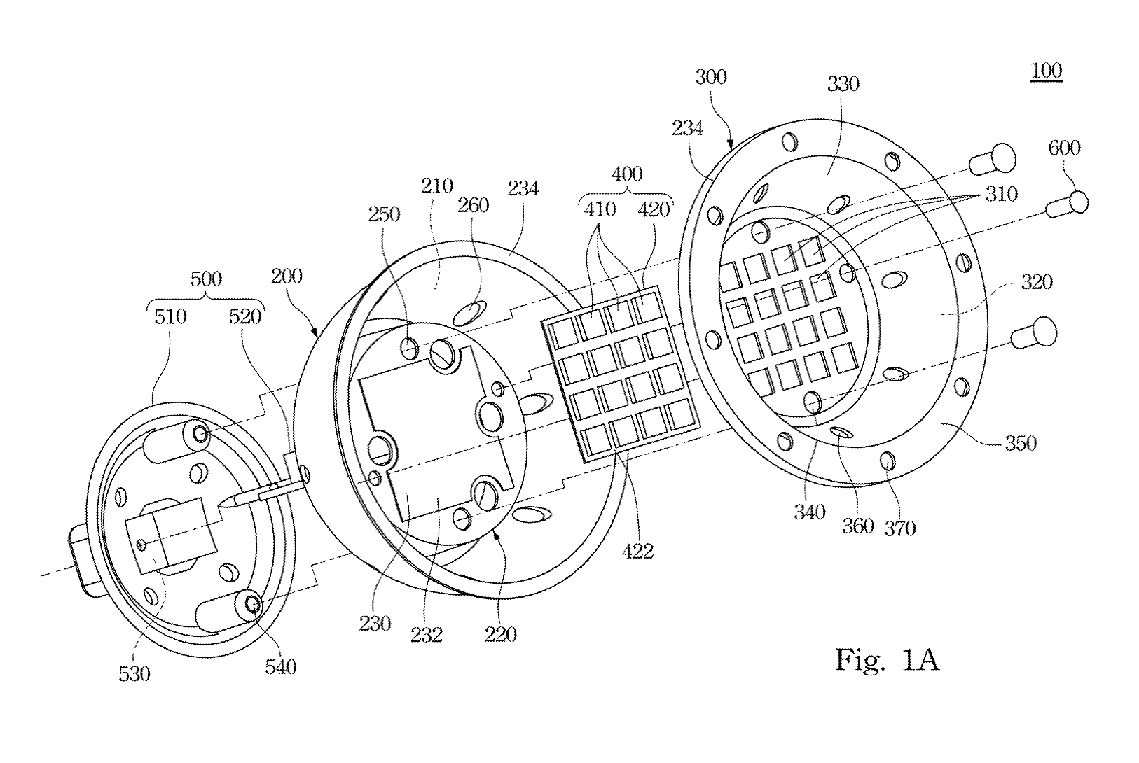

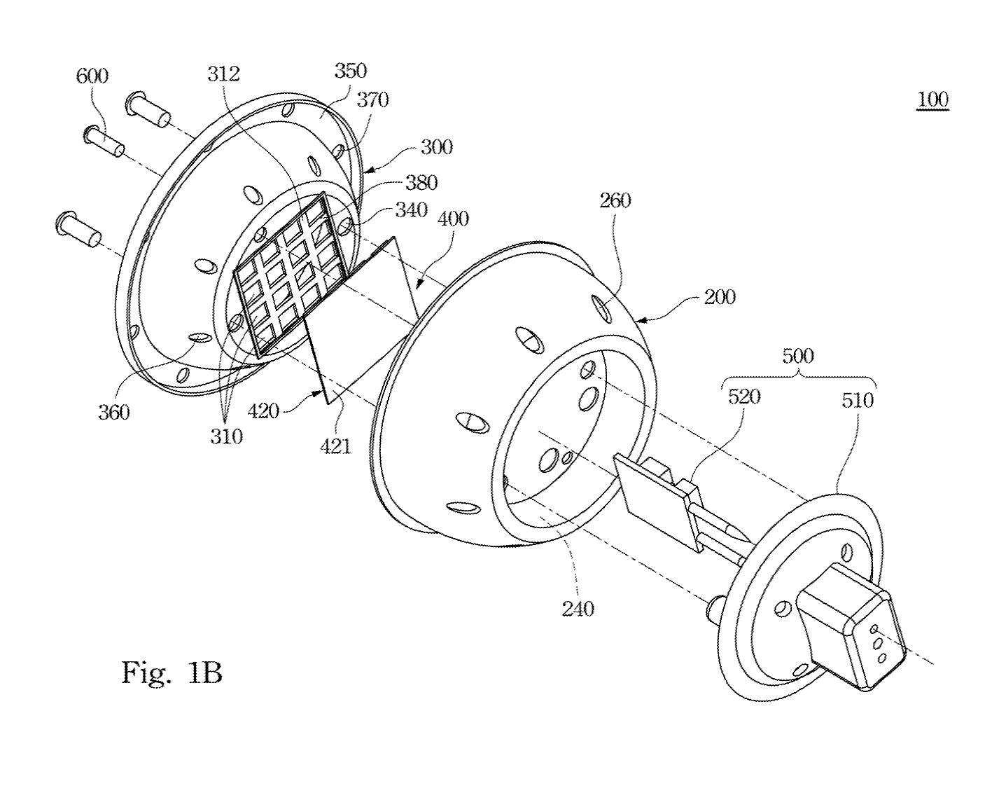

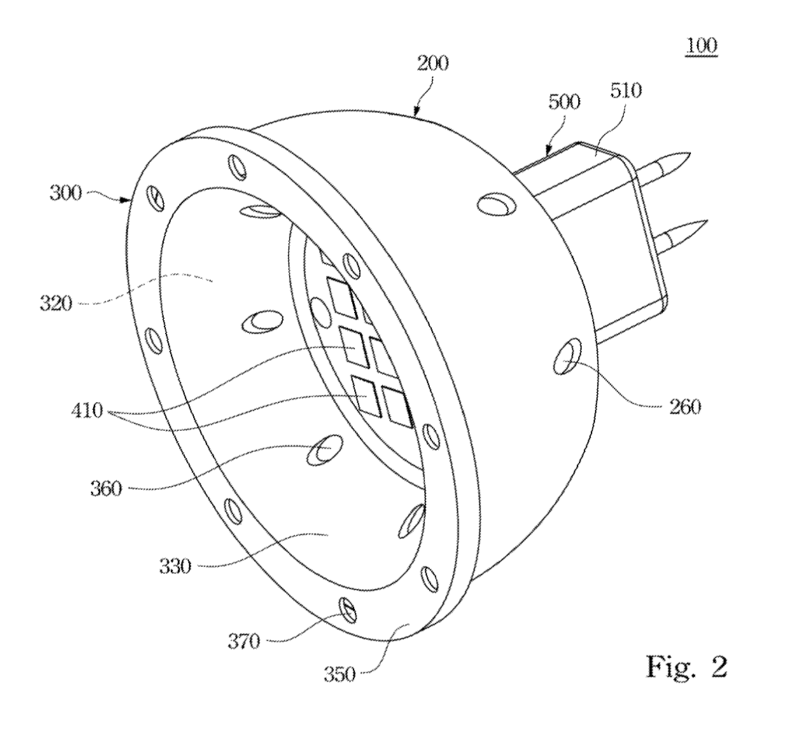

FIG. 1A is a perspective exploded view in a direction of an illuminating device with light emitting diodes of an embodiment of the present invention. FIG. 1B is a perspective exploded view in another direction of the illuminating device with light emitting diodes of the embodiment of the present invention. FIG. 2 is a perspective view of a combination of the illuminating device with light emitting diodes of the embodiment of the present invention.

As shown in FIG. 1A, FIG. 1B, and FIG. 2, in an embodiment of the present invention, an illuminating device 100 includes a rear housing 200, a front housing 300, an illuminating module 400, and a power-connecting portion 500.

The rear housing 200 has a cup or a bowl appearance. An opening first cavity 210 is defined by a sidewall surrounding the rear housing 200. A bottom surface of the rear housing 200 corresponding to the first cavity 210 includes a protruding portion 220. The protruding portion 220 extends into the first cavity 210. A surface of the protruding portion 220 disposed in the first cavity 210 is an assembling surface 230 for the illuminating module 400 disposed thereon. In addition, a first concave 240 (shown in FIG. 1 B) is formed on a side of the protruding portion 220 facing away from the front housing 300 for the power-connecting portion 500 disposed therein.

As shown in FIG. 1A, the front housing 300 with a cup or a bowl appearance is fixed in the first cavity 210. A second cavity 320 is defined by a sidewall surrounding the front housing 300. An interior wall of a sidewall of the front housing 300 surrounding the second cavity 320 includes a reflecting layer 330. The reflecting layer 330 can provide better illuminating efficiency. These through holes 310 are formed in an array arrangement on a bottom part of the front housing 300 corresponding to the second cavity 320. A second concave 380 (shown in FIG. 1 B) is formed on a surface of the bottom part of the front housing 300 facing the rear housing 200 and facing away from the second cavity 320. The second concave 380 communicates with every through hole 310.

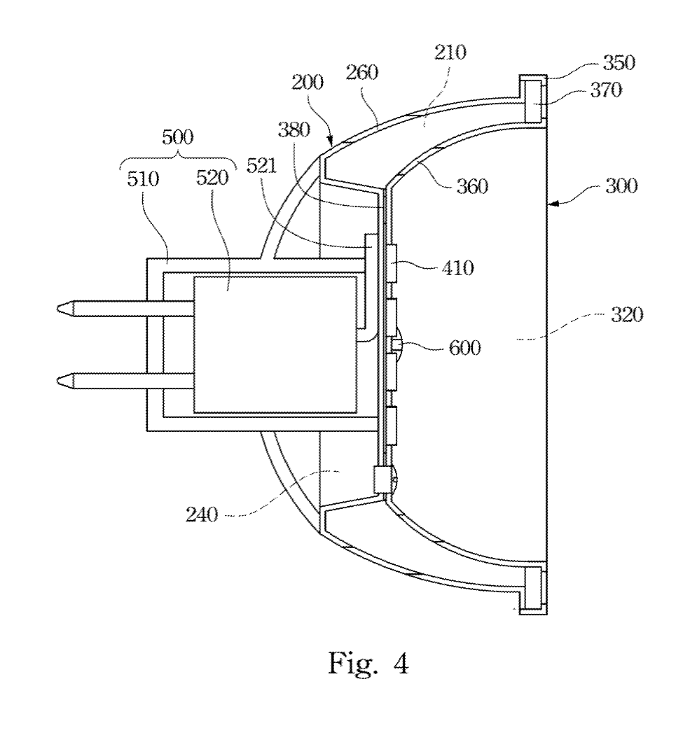

The power-connecting portion 500 is disposed on a surface of the rear housing 200 facing away from the front housing 300. The power-connecting portion 500 includes a bottom portion 510 and a power supply unit 520. The bottom portion 510 is disposed in the first concave 240 of the rear housing 200, and the bottom portion 510 includes a third concave 530 therein. The power supply unit 520, such as a voltage-transferring device, is disposed in the third concave 530. The power supply unit 520 would be electrically connected with the illuminating module 400 through the rear housing 200 and an external power supply by conducting wires 521 (shown in FIG. 4). However, the power supply unit 520 is not necessarily disposed in the third concave 530.

The illuminating module 400 further includes a substrate 420 and light emitting diodes 410. The substrate 420 includes a first surface 421 and a second surface 422 opposite to the first surface 421. The first surface 421 of the substrate 420 is in contact with the assembling surface 230 of the rear housing 200 directly. The second surface 422 of the substrate 420 is disposed into the second concave 380 and is in contact with a bottom surface of the second concave 380 of the front housing 300 directly. Simultaneously, these light emitting diodes 410 are correspondingly arranged on the second surface 422 of the substrate 420 in the array arrangement mentioned above, so that the light emitting diodes 410 can extend into the second cavity 320 through the through holes 310 in a one-to-one relationship.

In the above mentioned, the substrate 420 may be a printed circuit board or a metal board, wherein the printed circuit board means a board body with insulating properties including circuits capable of communicating signals thereon. The light emitting diodes 410 are packaged first, and then is soldered on the printed circuit board.

Alternatively, the metal board is made of cut metal board bodies. Any two adjacent metal board bodies includes a gap therebetween for separating the physically contact between the two adjacent board bodies, and the light emitting diodes 410 are packaged on the gap between the two adjacent metal board bodies directly. The metal conductive board is used as a conductive medium between the light emitting diodes 410 because of the conductive properties of the metal conductive board, thereby the light emitting diodes 410 would achieve series or parallel electrical connection generated therebetween by desirable shapes of the metal conductive board after cutting directly.

The assembling surface 230 of the rear housing 200 further includes many first bolt holes 250. A bottom surface of the front housing 300 facing the rear housing 200 further includes many second bolt holes 340. A surface of the bottom portion 510 facing the rear housing 200 includes corresponding fixing holes 540. Each of the first bolt holes 250, the second bolt holes 340, and the fixing holes 540 is disposed correspondingly. As such, when assembling the illuminating device 100, bolts 600 penetrate through the first bolt holes 250, the second bolt holes 340, and the fixing holes 540 in sequence, thereby a bottom of the front housing 300 may be fixed on the assembling surface 230 of the rear housing 200. Moreover, the substrate 420 of the illuminating module 400 is sandwiched between the front housing 300 and the rear housing 200, and the bottom portion 510 would be fixed in the first concave 240 of the rear housing 200, so that the power supply unit 520 is fixed in the third concave 530 (as shown in FIG. 2).

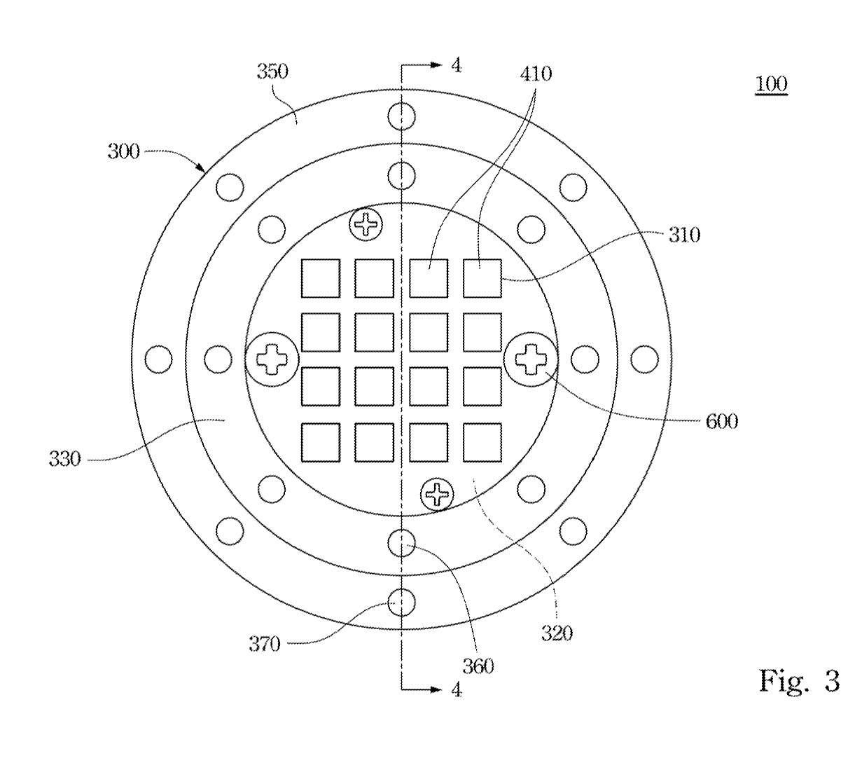

As shown in FIG. 3 and FIG. 4, FIG. 3 is a front schematic view of an illuminating device with light emitting diodes of the embodiment of the present invention, and FIG. 4 is a cross-sectional view taken along line 4-4 of FIG. 3.

In an embodiment of the present invention, radians of sidewalls of the front housing 300 and the rear housing 200 are different, thereby when the front housing 300 is disposed in the first cavity 210 of the rear housing 200, a gap of the first cavity 210 would be formed between sidewalls of the front housing 300 and the rear housing 200. Air holes 260 are formed on the sidewall of the rear housing 200, so that the first cavity 210 would communicate with outside air. For example, the first air holes 260 can surround the sidewall of the rear housing 200 with intervals, as show in FIG. 1A or FIG. 2.

The front housing 300 further includes second air holes 360, 370, so that the second cavity 320 and the first cavity 210 would communicate with outside air by the air holes 360, 370, as show in FIG. 4. As such, not only the heat generated from the illuminating device 100 would be conducted by the front housing 300 and the rear housing 200, but also the thermal energy generated from the working light emitting diodes 410 would be dissipated by the convection from the first cavity 210 to the second cavity 320 or outside. Additionally, cold air outside of the illuminating device 100 also can flow into the second cavity 320 and the, first cavity 210 for rapidly enhancing the heat exchange efficiency of the illuminating device 100.

For example, in an embodiment of the second air holes, the second air holes 360 may surround the sidewall of the front housing 300 (shown in FIG. 3) with intervals and are arranged correspondingly to the first air holes one-to-one, thereby communicating with outside air rapidly. Alternately, in another embodiment of the second air holes, an edge of an opening of the front housing 300 corresponding to the second cavity 320 includes a ring-shaped flange 350 extending to outside. The ring-shaped flange 350 is connected with an edge of an opening of the rear housing 200 for covering the first cavity 210. The second air holes 370 are arranged on the ring-shaped flange 350 with intervals, therefore the second air holes 370 would communicate with the first air holes 260 by the gap formed between the front housing 300 and the rear housing 200. Furthermore, as shown in FIG. 4, the present invention may include different second air holes 360, 370 disposed on the front housing 300 capable of better enhancing the heat exchange efficiency of the illuminating device 100.

In another embodiment of the present invention, the front housing 300 and the rear housing 200 may be made of metal or plastic. The metal is provided with high thermal conductivity, such as silver, copper, gold, nickel, aluminum, tin, chromium, and alloy composed of above mentioned.

However, when the front housing 300 and the rear housing 200 are made of metal, a first insulating layer 232 may be formed on the surface of the rear housing 200 by electrically insulating treatment, and a second insulating layer 312 may be formed on the surface of the front housing 300 by an electrically insulating treatment. Practically, in an economical way, at least the assembling surface 230 of the rear housing 200 for being in contact with the first surface 421 of the substrate 420 includes the first insulating layer 232, and at least the surface of the second concave 380 of the front housing 300 for being in contact with the second surface 422 includes the second insulating layer 312. The first and the second insulating layers 232, 312 can be the same or different products. These products with insulating layers may be insulating paint, anodic treatment layers or dissipation adhesives, etc.

Besides, no matter the front housing 300 and the rear housing 200 are made of metal or plastic, the surface of the front housing 300 or the rear housing 200 may include a heat dissipation layer 234, wherein the heat dissipation layer 234 may be a carbon deposit layer, a diamond deposit layer, or other deposit layer with high thermal conductivity.

To sum up, the illuminating device 100 with light emitting diodes 410 of the present invention increases the area in contact with the light emitting diodes 410 to highly reduce the working temperature of the light emitting diodes 410, thereby decreasing the failure probability of the light emitting diodes 410 due to the insufficient heat dissipation efficiency. Furthermore, the illuminating device 100 with light emitting diodes 410 of the present invention improves convective condition of the air so as to enhance the heat exchange rate.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An illuminating device with light emitting diodes comprising:
a rear housing comprising a first cavity therein;
a front housing disposed in the first cavity and comprising a second cavity and a plurality of through holes therein, wherein the through holes communicate with the second cavity; and
an illuminating module sandwiched between the rear housing and the front housing, the illuminating module comprising:
a substrate comprising a first surface and a second surface opposite to the first surface, wherein the first surface is in contact with the rear housing directly, and the second surface is in contact with the front housing directly; and
a plurality of light emitting diodes arranged on the second surface of the substrate in an array arrangement and extending into the second cavity through the through holes in a one-to-one relationship.

2. The illuminating device with light emitting diodes as claimed in claim 1, wherein the rear housing comprises a plurality of first air holes, and the first air holes communicate with the first cavity of the rear housing and outside air.

3. The illuminating device with light emitting diodes as claimed in claim 2, wherein the front housing further comprises a plurality of second air holes, and the second air holes communicate with the second cavity of the front housing and the first cavity of the rear housing.

4. The illuminating device with light emitting diodes as claimed in claim 3, wherein the second air holes are disposed on a sidewall of the front housing.

5. The illuminating device with light emitting diodes as claimed in claim 3, wherein the front housing comprises an opening, an edge of the opening comprises a ring-shaped flange extending outwards, and the second air holes are disposed on the ring-shaped flange.

6. The illuminating device with light emitting diodes as claimed in claim 1, wherein an interior wall of a sidewall of the front housing surrounding the second cavity comprises a reflecting layer disposed thereon.

7. The illuminating device with light emitting diodes as claimed in claim 1 further comprising a power-connecting portion disposed on a surface of the rear housing facing away from the front housing.

8. The illuminating device with light emitting diodes as claimed in claim 1, further comprising a first insulating layer disposed on a surface of the rear housing in contact with the first surface of the substrate and a second insulating layer disposed on a surface of the front housing in contact with the second surface of the substrate.

9. The illuminating device with light emitting diodes as claimed in claim 1, further comprising a heat dissipation layer disposed on a surface of the rear housing or the front housing.

10. The illuminating device with light emitting diodes as claimed in claim 1, wherein the substrate is a printed circuit board or a metal board.
